(19) United States
(12) Patent Application Publication
(10) Pub. No.: US 2023/0393897 A1
(43) Pub. Date: Dec. 7, 2023

(54) SIGNAL PROCESSING DEVICE, SIGNAL PROCESSING METHOD, AND IMAGING APPARATUS

(71) Applicant: Sony Semiconductor Solutions Corporation, Kanagawa (JP)

(72) Inventors: Goshi Watanabe, Saitama (JP); Kazuyuki Okuike, Kanagawa (JP); Hiroshi Katayama, Tokyo (JP)

(21) Appl. No.: 18/033,745

(22) PCT Filed: Oct. 12, 2021
(86) PCT No.: PCT/JP2021/037795

§ 371 Date: Apr. 25, 2023

(30) Foreign Application Priority Data
Nov. 9, 2020 (JP) 2020-186819

(51) Int. Cl. G06F 9/50; H04N 23/45

(52) U.S. Cl. CPC G06F 9/5038; H04N 23/45

(57) ABSTRACT

A signal processing device according to the present disclosure includes: multiple input units that add additional information necessary for signal processing to each of multiple pieces of data inputted from respective multiple external devices, and output the multiple pieces of data; and multiple stages of processing units each configured to perform common signal processing on each of the multiple pieces of data, on the basis of the additional information.

### TECHNICAL FIELD

The present disclosure relates to a signal processing device, a signal processing method, and an imaging apparatus that perform signal processing on each of multiple pieces of data.

### BACKGROUND ART

In recent years, camera-mounted equipment such as a smartphone has come to be mounted with multiple kinds of sensors including, for example, an RGB sensor, a monochrome sensor, a range sensor, and a deflection sensor. In such camera-mounted equipment, different signal processing is necessary for each of the kinds of the multiple sensors in some cases, and it is possible to perform signal processing in common to the multiple sensors in some cases. In general, hardware that performs signal processing is prepared as a dedicated block for each sensor. Therefore, an increase in the number of sensor results in an increase in hardware scale. On the other hand, there is a method of sharing a signal processing system block by multiple sensors, by using a CPU (Central Processing Unit) or a DFP (Data Flow Processor) dedicated to data flow (see PTL 1).

### CITATION LIST

### Patent Literature

PTL 1: Japanese Unexamined Patent Application Publication No. H5-265880

### SUMMARY OF THE INVENTION

In a case of sharing a signal processing system block by multiple sensors by using a CPU or a DFP, a limitation is imposed due to performance of the CPU or the DFP. In addition, using the DFP brings about an increase in circuit scale and electric power consumption.

It is desirable to provide a signal processing device, a signal processing method, and an imaging apparatus that are able to perform signal processing on multiple pieces of data, while suppressing a circuit scale and electric power consumption.

A signal processing device according to an embodiment of the present disclosure includes: multiple input units that add additional information necessary for signal processing to each of multiple pieces of data inputted from respective multiple external devices, and output the multiple pieces of data; and multiple stages of processing units each configured to perform common signal processing on each of the multiple pieces of data, on the basis of the additional information.

A signal processing method according to an embodiment of the present disclosure includes: adding additional information necessary for signal processing to each of multiple pieces of data inputted from respective multiple external devices, and outputting the multiple pieces of data; and performing, in each of multiple stages of processing units, common signal processing on each of the multiple pieces of data, on the basis of the additional information.

An imaging apparatus according to an embodiment of the present disclosure includes: multiple sensors; multiple input units that add additional information necessary for signal processing to each of multiple pieces of data inputted from the respective multiple sensors, and output the multiple pieces of data; and multiple stages of processing units each configured to perform common signal processing on each of the multiple pieces of data, on the basis of the additional information.

In the signal processing device, the signal processing method, or the imaging apparatus according to the embodiment of the present disclosure, in each of the multiple stages of processing units, common signal processing is performed on each of the multiple pieces of data, on the basis of the additional information added to each of the multiple pieces of data.

### BRIEF DESCRIPTION OF THE DRAWINGS

FIG, 1 is a block diagram illustrating a configuration example of a signal processing device according to a comparative example.

FIG. 2 is a block diagram illustrating a configuration example of a signal processing device according to a first embodiment of the present disclosure.

FIG, 3 is a block diagram illustrating a configuration example of an input unit in the signal processing device according to the first embodiment.

FIG. 4 is a block diagram illustrating a first configuration example of a processing unit in the signal processing device according to the first embodiment,

FIG. 5 is a block diagram illustrating a second configuration example of the processing unit in the signal processing device according to the first embodiment.

FIG. 6 is a block diagram illustrating a first specific example of a configuration of the signal processing device according to the first embodiment.

FIG. 7 is a block diagram illustrating a second specific example of the configuration of the signal processing device according to the first embodiment.

FIG. 8 is an explanatory diagram schematically illustrating operation timing of signal processing by a signal processing device according to a comparative example.

FIG. 9 is an explanatory diagram schematically illustrating operation timing of signal processing by the signal processing device according to the second specific example.

FIG. 10 is a block diagram illustrating a third specific example of the configuration of the signal processing device according to the first embodiment.

FIG. 11 is a block diagram illustrating a fourth specific example of the configuration of the signal processing device according to the first embodiment.

FIG. 12 is a block diagram illustrating a specific example of queue processing to be performed by a queue processor in the signal processing device according to the first embodiment.

FIG. 13 is a block diagram illustrating a fifth specific example of the configuration of the signal processing device according to the first embodiment.

FIG. 14 is a block diagram illustrating a specific example of queue processing to be performed by the queue processor in the signal processing device according to the first embodiment.

FIG. 15 is a block diagram illustrating a sixth specific example of the configuration of the signal processing device according to the first embodiment.

FIG. 16 is an explanatory diagram illustrating an example of additional information to be added by the signal processing device according to the first embodiment.

FIG, 17 is a block diagram illustrating a seventh specific example of the configuration of the signal processing device according to the first embodiment.

FIG. 18 is an explanatory diagram illustrating an example of the additional information to be added by the signal processing device according to the seventh specific example.

FIG. 19 is an explanatory diagram illustrating an example of an amount of electric power consumed by the processing unit in the signal processing device according to the comparative example. v FIG. 20 is an explanatory diagram illustrating an example of an amount of electric power consumed by the processing unit in the signal processing device according to the first embodiment.

FIG, 21 is a flowchart illustrating an example of operation related. to each of multiple input units in the signal processing device according to the first embodiment.

FIG. 22 is a flowchart illustrating an example of operation related to multiple processing units in each of the signal processing device according to the first embodiment.

### MODES FOR CARRYING OUT THE INVENTION

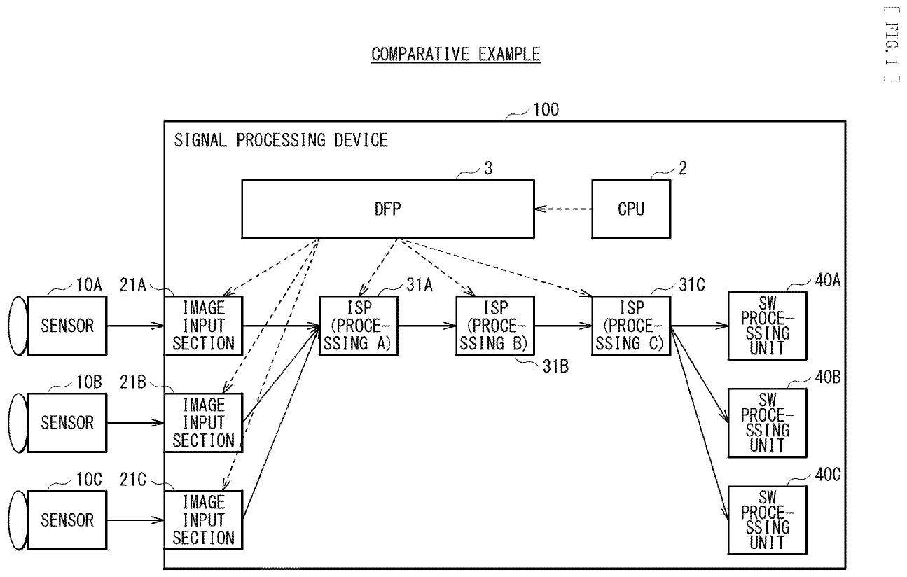

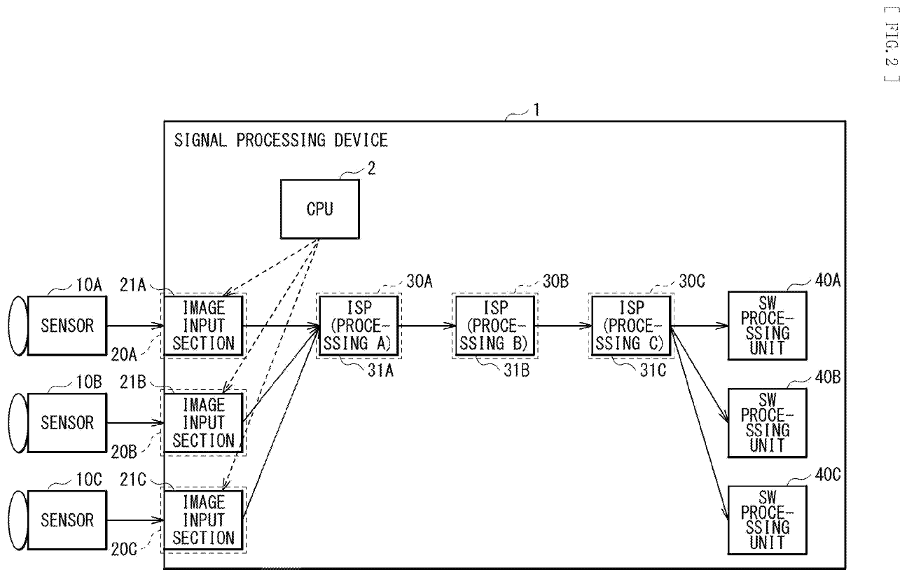

In the following, description is given of embodiments of the present disclosure in detail with reference to the drawings. It is to be noted that the description is given in the following order.
0. Comparative Example (FIG. 1)
1. First Embodiment (FIGS. 2 to 22)
   1.1 Overview
   1.2 Specific Examples
   1.3 Operation
   1.4 Effects
2. Other Embodiments

### 0. Comparative Example

### Overview of Signal Processing Device According to Comparative Example

FIG. 1 illustrates a configuration example of a signal processing device 100 according to a comparative example.

FIG. 1 illustrates a configuration example in a case of processing data. outputted from multiple sensors 10A, 10B, and 10C serving as multiple external devices. The multiple sensors 10A, 10B, and 10C each output, for example, image data. The multiple external devices and the signal processing device 100 may configure an imaging apparatus as a whole.

The signal processing device 100 according to the comparative example includes multiple image input sections 21A, 21B, and 21C provided to correspond respectively to - the multiple sensors 10A, 10B, and 10C. To the multiple image input sections 21A, 21B, and 21C, pieces of data from the multiple sensors 10A, 10B, and 10C are inputted respectively.

The signal processing device 100 further includes a CPU 2, a DFP 3, multiple stages of signal processing system hardware, and multiple SW processing units (software) 40A, 40B, and 40C.

The multiple SW processing units 40A, 40B, and 40C are provided to correspond respectively to the multiple sensors 10A, 10B, and 10C. To each of the multiple SW processing units 40A, 40B, and 40C, data after signal processing by the multiple stages of signal processing system hardware is inputted.

FIG. 1 illustrates a configuration example in a case where multiple stages of ISPs (Image Signal Processors) 31A, 31B, and 31C that perform image processing are present, as the multiple stages of signal processing system hardware. The multiple stages of ISPs 31A, 31B, and 31C are each shared by the multiple sensors 10A, 10B, and 10C, and able to perform common signal processing (processing A, processing B, and processing C) on each of multiple pieces of data.

The DFP 3 is controlled by the CPU 2. The DFP 3 controls a setting value and operation timing (data flow) of each of the multiple image input sections 21A, 21B, and 21C and the multiple stages of ISPs 31A, 31B, and 31C. The multiple stages of ISPs 31A, 31B, and 31C perform signal processing time-divisionally, under the control of the DFP 3, on the respective pieces of data from the multiple sensors 10A, 10B, and inputted via the multiple sensors 10A, 10B, and 10C.

### Issue

In the signal processing device 100 according to the comparative example, if the multiple stages of signal processing system hardware are subjected to data flow control by the CPU 2, performance of the CPU 2 imposes a limitation. Hence, performing data flow control by using the DFP 3 dedicated to data flow allows signal processing to be performed without being limited by the performance of the CPU 2. Here, even though the DFP 3 is dedicated to data flow and thus has high throughput, signal processing executable with performance of the DFP 3 is limited.

Hence, it is desired to develop a technique that makes it possible to perform signal processing not limited by the performance of the CPU 2 or the DFP 3. In addition, it is desired to develop a technique that makes it possible to perform signal processing on multiple pieces of data. While suppressing a circuit scale and electric power consumption.

### 1. First Embodiment

### 1.1 Overview

FIG. 2 schematically illustrates a configuration example of a signal processing device 1 according to a first embodiment of the present disclosure. Note that description is omitted as appropriate regarding portions, in FIG. 2, having configurations and operations similar to those of the signal processing device 100 according to the comparative example in FIG. 1.

FIG. 2 illustrates a configuration example in a case of processing data outputted from the multiple sensors 10A, 10B, and 10C serving as the multiple external devices, as with the signal processing device 100 according to the comparative example. The multiple sensors 10A, 10B, and 10C each output, for example, image data. The multiple external devices and the signal processing device 1 may configure an imaging apparatus as a whole.

The signal processing device 1 according to the first embodiment includes multiple input units 20A, 20B, and 20C provided to correspond respectively to the multiple sensors 10A, 10B, and 10C. To the multiple input units 20A, 20B, and 20C, pieces of data from the multiple sensors 10A, 10B, and 10C are inputted respectively.

The signal processing device 1 further includes the CPU 2, multiple stages of signal processing system hardware, and the multiple SW processing units 40A, 40B, and 40C.

Note that the multiple external devices may be two or four or more external devices. In addition, in accordance with the number of the multiple external devices, the multiple input units 20A, 20B, and 20C may also be two or four or more input units. Similarly, in accordance with the number of the multiple external devices, the multiple SW processing units 40A, 40B, and 40C may also be two or four or more SW processing units.

FIG. 2 illustrates a configuration example in a case where multiple stages of processing units 30A, 30B, and 30C are present, as the multiple stages of signal processing system hardware. The multiple stages of processing units 30A, 30B, and 30C are each shared by the multiple sensors 10A, 10B, and 10C, and able to perform common signal processing (processing A, processing B, and processing C) on each of multiple pieces of data. Note that the multiple stages of signal processing system hardware may be two or four or more stages of signal processing system hardware.

The multiple input units 20A, 20B, and 20C include the multiple image input sections 21A, 21B, and 21C respectively. The multiple stages of processing units 30A, 30B, and 30C include the multiple stages of ISPs 31A, 31B, and 31C respectively.

FIG. 3 illustrates a configuration example of an input unit 20x in the signal processing device 1. Here, the input unit 20x represents any one of the multiple input units 20A, 20B, and 20C. An image input section 21x represents any one of the multiple image input sections 21A, 21B, and 21C.

The multiple input units 20A, 20B, and 20C generate and output data obtained by adding additional information necessary for signal processing to each of multiple pieces of data inputted from the respective multiple sensors 10A, 10B, and 10C.

The multiple input units 20A, 20B, and 20C each include a packet generator 22 serving as a first packet generator, in an output stage of corresponding one of the multiple image input sections 21A, 21B, and 21C, The packet generator 22 generates a packet of each of the multiple pieces of data inputted from the respective multiple sensors 10A, 10B, and 10C, adds the additional information as a header to the packet, and outputs the packet.

Here, the additional information may include instruction information indicating a routing instruction as to signal processing using which processing unit, out of the multiple stages of processing units 30A, 30B, and 30C, is to be performed on each of the multiple pieces of data. In addition, the additional information may include setting information indicating a setting value to be used for signal processing in each of the multiple stages of processing units 30A, 30B, and 30C.

The CPU 2 serves as a controller that instructs each of the multiple input units 20A, 20B, and 20C as to signal processing using which processing unit, out of the multiple stages of processing units 30A, 30B, and 30C, is to be performed.

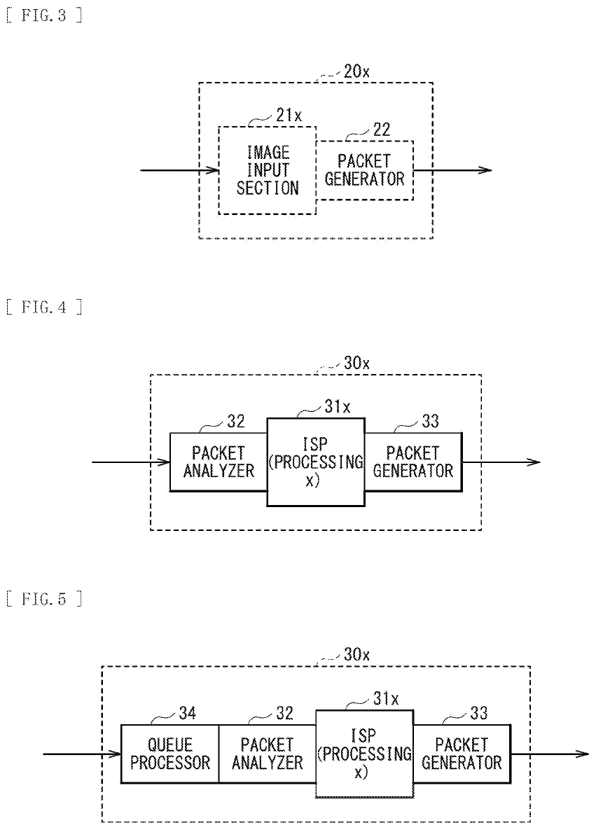

FIG. 4 illustrates a first configuration example of a processing unit 30x in the signal processing device 1. Here, the processing unit 30x represents any one of the multiple stages of processing units 30A, 30B, and 30C. An ISP 31x represents any one of the multiple stages of ISPs 31A, 31B, and 31C.

The multiple stages of processing units 30A, 30B, and 30C are each configured to perform common signal processing on each of the multiple pieces of data, on the basis of the additional information.

The multiple stages of processing units 30A, 30B, and 30C each include a packet analyzer 32, and a packet generator 33 serving as a second packet generator.

The packet analyzer 32 is provided in an input stage of each of the multiple stages of ISPs 31A, 31B, and 31C. The packet generator 33 is provided in an output stage of each of the multiple stages of ISPs 31A, 31B, and 31C.

The packet analyzer 32 analyzes the header added to the packet, and determines the setting value to be used for signal processing in the ISP 31x.

The packet generator 33 generates a packet in which information to be used for signal processing of the processing unit in the next stage, out of the multiple stages of ISPs 31A, 31B, and 31C, is added as additional information to a header.

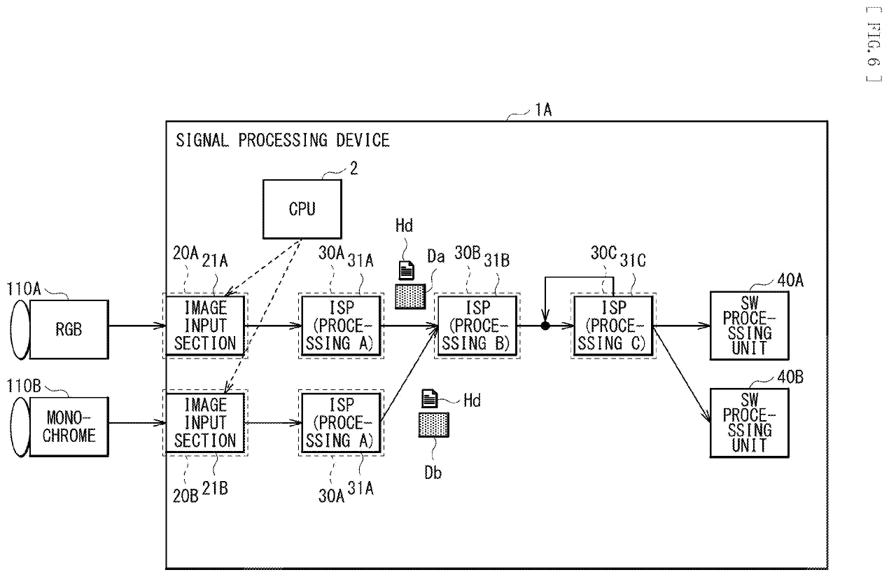

FIG. 5 illustrates a second configuration example of the processing unit 30x in the signal processing device 1.

The additional information to be added by each of the multiple input units 20A, 20B, and 20C may include information indicating a priority for signal processing of each of the multiple pieces of data, in each of the multiple stages of processing units 30A, 30B, and 30C.

The multiple stages of processing units 30A, 30B, and 30C may each include a queue processor 34 in an input stage of the packet analyzer 32.

The queue processor 34 performs queue processing on each of the multiple pieces of data, on the basis of the information indicating the priority, as will be described later. In a case where a queue overflow occurs, the queue processor 34 may discard data of which the priority is relatively low, out of the multiple pieces of data, as will be described later.

The CPU 2 may be a controller that is able to adjust the setting value of each of the multiple sensors 10A, 10B, and 10C. In a case where a queue overflow occurs, the queue processor 34 may provide the CPU 2 with a notification that the queue overflow has occurred, as will be described later. The CPU 2 may adjust the setting value of each of the multiple sensors 10A, 10B, and 10C, on the basis of the notification from the queue processor 34.

In the signal processing device 1 configured as described above, for example, before startup of the device, the CPU 2 gives, to each of the multiple input units 20A, 20B, and 20C, the additional information including, for example, a routing instruction as to signal processing using which processing unit, out of the multiple stages of processing units 30A, 30B, and 30C, is to be performed. This allows each processing unit to route and process data automatically, without being controlled by the CPU 2. In the signal processing device 1, making it possible to perform data flow processing in the signal processing system hardware makes it unnecessary for data flow to be controlled by the CPU 2 or the DSP 3 (FIG. 1). This allows for processing regardless of a limitation imposed by the CPU 2 or the DSP 3, even in a case where the number of external devices is increased, for example, to 10 and further to 20.

### 1.2 Specific Examples

Next, more specific configuration examples of the signal processing device 1 according to the first embodiment are described. Note that description is omitted as appropriate regarding portions having configurations and operations similar to those in FIG. 2.

### First Specific Example

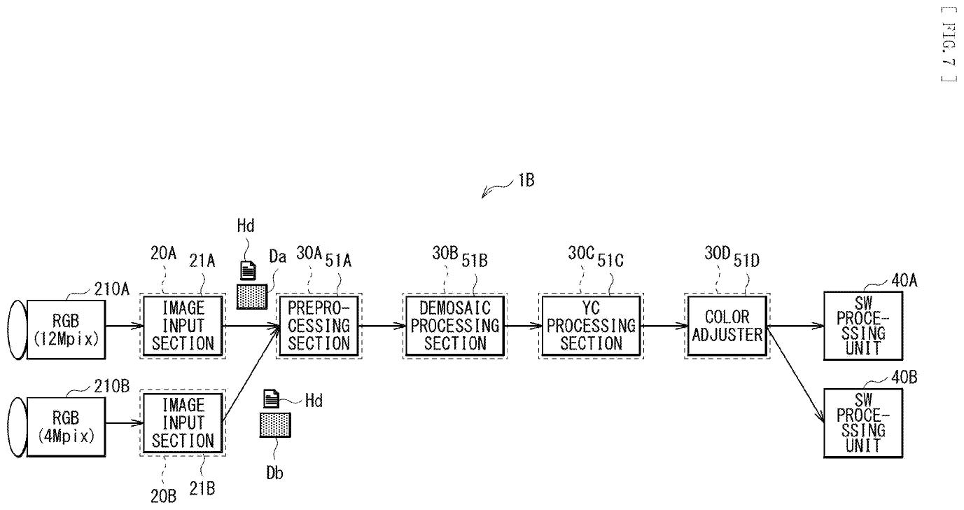

FIG. 6 illustrates a first specific example of a configuration of the signal processing device 1 according to the first embodiment.

A signal processing device 1A according to the first specific example illustrated in FIG. 6 represents a configuration example in a case of processing data outputted from an RGB sensor 110A and a monochrome sensor 110B as the multiple external devices. The multiple external devices and the signal processing device 1A may configure an imaging apparatus as a whole.

The signal processing device 1A includes the multiple input units 20A and 20B provided to correspond to the RGB sensor 110A and the monochrome sensor 110B. The data from the RGB sensor 110A is inputted to the input unit 20A. The data from the monochrome sensor 110B is inputted to the input unit 20B.

The signal processing device 1A further includes the CPU 2, multiple stages of signal processing system hardware, and the multiple SW processing units 40A and 40B.

FIG. 6 illustrates a configuration example in a case where the multiple stages of processing units 30A, 30B, and 30C provided to correspond to the RGB sensor 110A are present, as the multiple stages of signal processing system hardware. In addition, FIG. 6 illustrates a configuration example in a case where one processing unit 30A provided to correspond to the monochrome sensor 110B is present, as the signal processing system hardware.

On the basis of an instruction from the CPU 2, the input unit 20A generates a packet in which additional information including, for example, a routing instruction is added to a header Hd of data Da from the RGB sensor 110A, and outputs the packet to the processing unit 30A provided to correspond to the RGB sensor 110A.

On the basis of an instruction from the CPU 2, the input unit 20B generates a packet in which additional information including, for example, a routing instruction is added to a header Hd of data Db from the monochrome sensor 110B, and outputs the packet to the processing unit 30A provided to correspond to the monochrome sensor 110B.

To the processing unit 30B, the data Da from the processing unit 30A provided to correspond to the RGB sensor 110A, and the data Db from the processing unit 30A provided to correspond to the monochrome sensor 110B are inputted in common. The processing unit 30B performs processing of the data Da and the data Db time-divisionally, on the basis of the additional information indicated by the header Hd.

The processing unit 30B performs signal processing of the data Da and the data Db time-divisionally, on the basis of the additional information indicated by the header Hd. The processing unit 30B outputs the data Db after signal processing to the SW processing unit 40B. In contrast, the processing unit 30B outputs the data Da after signal processing to the processing unit 30C in the next stage. The processing unit 30C outputs the data Da after signal processing to the SW processing unit 40A.

Note that the multiple stages of processing units 30A, 30B, and 30C may each repeat multiple times of signal processing, depending on contents of signal processing. For example, noise reduction processing or the like may be executed multiple times as signal processing. FIG. 6 illustrates an example in which the processing unit 30C repeats multiple times of signal processing.

### Second Specific Example

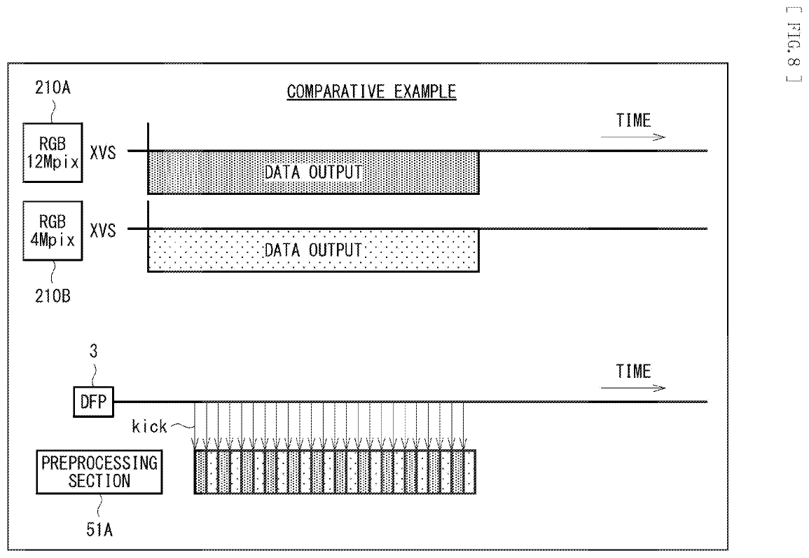

FIG. 7 illustrates a second specific example of the configuration of the signal processing device 1 according to the first embodiment.

A signal processing device 1B according to the second specific example illustrated in FIG. 7 represents a configuration example in a case of processing data outputted from an RGB sensor 210A and an RGB sensor 210B having different pixel sizes from each other, as the multiple external devices. The multiple external devices and the signal processing device 1B may configure an imaging apparatus as a whole. Note that illustration of the CPU 2 is omitted in FIG. 7.

The RGB sensor 210A is an image sensor having a higher resolution than the RGB sensor 210B. FIG. 7 illustrates an example in which the pixel size of the RGB sensor 210A is, for example, 12 Mpix, and the pixel size of the RGB sensor 210B is, for example, 4 Mpix.

The signal processing device 1B includes the multiple input units 20A and provided to correspond to the RGB sensor 210A and the RGB sensor 210B. The data from the RGB sensor 110A is inputted to the input unit 20A. The data from the RGB sensor 210B is inputted to the input unit 20B.

The signal processing device 1B further includes the unillustrated CPU 2, multiple stages of signal processing system hardware, and the multiple SW processing units 40A and 40B.

FIG. 7 illustrates a configuration example in a case where multiple stages of processing units 30A, 30B, 30C, and 30D provided in common to each of the RGB sensor 210A and the RGB sensor 210B are present, as the multiple stages of signal processing system hardware.

The processing unit 30A includes a preprocessing section 51A. The processing unit 30B includes a demosaic processing section 51B. The processing unit includes a Y (luminance) C (chroma) processing section. The processing unit 30D includes a color adjuster 51D.

On the basis of an instruction from the CPU 2, the input unit 20A generates a packet in which additional information including, for example, a routing instruction is added to the header Hd of the data Da from the RGB sensor 210A, and outputs the packet to the processing unit 30A.

On the basis of an instruction from the CPU 2, the input unit 20B generates a packet in which additional information including, for example, a routing instruction is added to the header Hd of the data Db from the RGB sensor 210B, and outputs the packet to the processing unit 30A.

The multiple stages of processing units 30A, 30B, 30C, and 30D each perform processing of the data Da and the data Db time-divisionally, on the basis of the additional information indicated by the header Hd. The processing unit 30D outputs the data Da after signal processing to the SW processing unit 40A, and outputs the data Db after signal processing to the SW processing unit 40A.

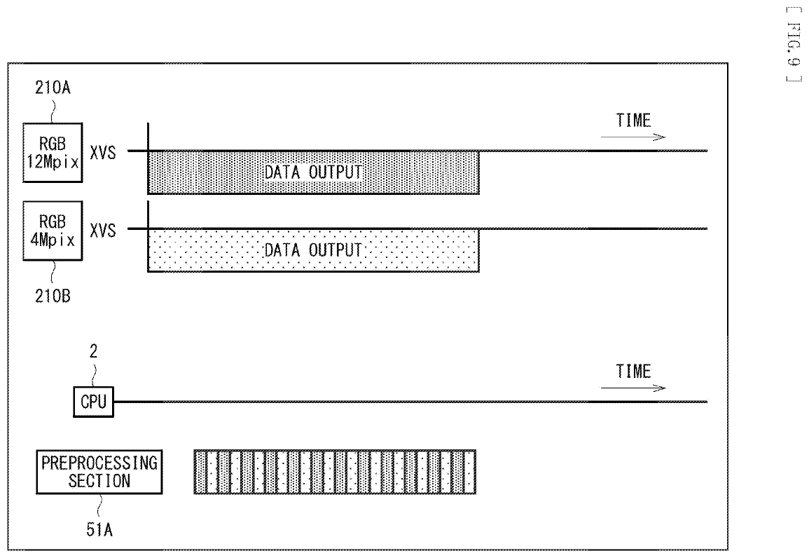

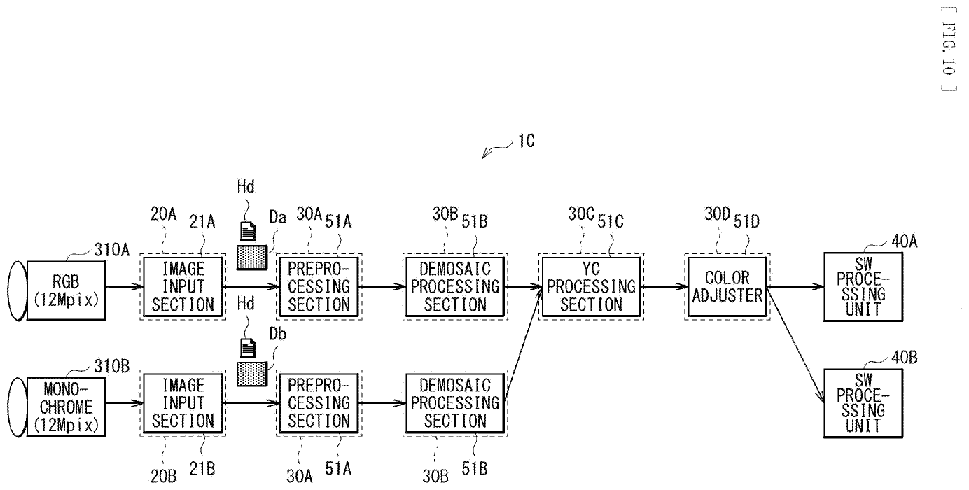

FIG. 8 schematically illustrates operation timing of signal processing by a signal processing device according to a comparative example. FIG. 8 illustrates an example case where the multiple stages of processing units 30A, 30B, 30C, and 30D are controlled by the DFP 3, as the signal processing device according to the comparative example. FIG. 9 schematically illustrates operation timing of signal processing by the signal processing device 1B according to the second specific example.

FIGS. 8 and 9 illustrate, in an upper stage, a timing example of data output from each of the RGB sensors 210A and 210B. In each of the signal processing device according to the comparative example and the signal processing device 1B according to the second specific example, data is continuously outputted from each of the RGB sensors 210A and 210B.

FIG. 8 illustrates, in a lower stage, a timing example of signal processing by the DFP 3 and the preprocessing section 51A in the processing 30A. FIG. 9 illustrates, in a lower stage, a timing example of signal processing by the CPU 2 and the preprocessing section 51A in the processing unit 30A.

In the signal processing device according to the comparative example, control (kick) by the DFP 3 is necessary, each time the preprocessing section 51A processes the data from each of the RGB sensors 210A and 210B time-divisionally. Therefore, processing is limited by performance of the DFP 3. In contrast, in the signal processing device 1B according to the second specific example, the preprocessing section 51A operates autonomously on the basis of the additional information indicated by the header Hd and performs signal processing. Therefore, when processing the data from each of the RGB sensors 210A and 210B time-divisionally, control by the CPU 2 is unnecessary, and the processing is not limited by performance of the CPU 2.

### Third Specific Example

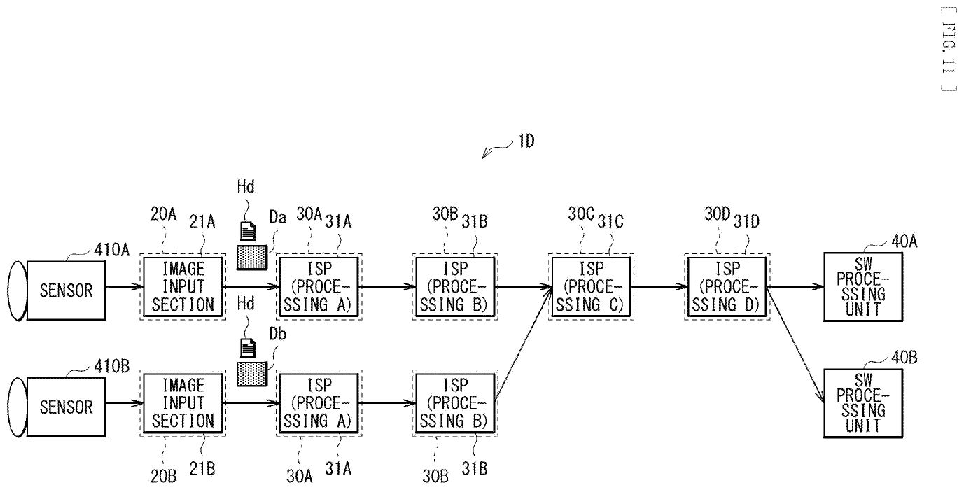

FIG. 10 illustrates a third specific example of the configuration of the signal processing device 1 according to the first embodiment.

A signal processing device 1C according to the third specific example illustrated in FIG. 10 represents a configuration example in a case of processing data outputted from an RGB sensor 310A and a monochrome sensor 310B as the multiple external devices. The multiple external devices and the signal processing device 1C may configure an imaging apparatus as a whole. Note that illustration of the CPU 2 is omitted in FIG. 10.

FIG. 10 illustrates an example in which the RGB sensor 310A and the monochrome sensor 310B have the same pixel size, for example, 12 Mpix.

The signal processing device 1C includes the multiple input units 20A and 20B provided to correspond to the RGB sensor 310A and the monochrome sensor 310B. The data from the RGB sensor 310A is inputted to the input unit 20A. The data from the monochrome sensor 310B is inputted to the input unit 20B.

The signal processing device 1C further includes the unillustrated CPU 2, multiple stages of signal processing system hardware, and the multiple SW processing units 40A and 40B.

FIG. 10 illustrates a configuration example in a case where the multiple stages of processing units 30A, 30B, 30C, and 30D provided to correspond to the RGB sensor 310A are present, as the multiple stages of signal processing system hardware. In addition, FIG. 10 illustrates a configuration example in a case where the multiple stages of processing units 30A and 30B provided to correspond to the monochrome sensor 310B are present, as the signal processing system hardware.

The processing unit 30A includes the preprocessing section 51A. The processing unit 30B includes the demosaic processing section 51B. The processing unit includes the Y (luminance) C (chroma) processing section. The processing unit 30D includes the color adjuster 51D.

On the basis of an instruction from the CPU 2, the input unit 20A generates a packet in which additional information including, for example, a routing instruction is added to the header Hd of the data Da from the RGB sensor 310A, and outputs the packet to the processing unit 30A provided to correspond to the RGB sensor 310A. The data Da from the processing unit 30A provided to correspond to the RGB sensor 110A is inputted to the processing unit 30B provided to correspond to the RGB sensor 310A.

On the basis of an instruction from the CPU 2, the input unit 20B generates a packet in which additional information including, for example, a routing instruction is added to the header Hd of the data Db from the monochrome sensor 310B, and outputs the packet to the processing unit 30A provided to correspond to the monochrome sensor 310B. The data Db from the processing unit 30A provided to correspond to the monochrome sensor 310B is inputted to the processing unit 30B provided to correspond to the monochrome sensor 310B.

To the processing unit 30C, the data Da from the processing unit 30B provided to correspond to the RGB sensor 310A, and the data Db from the processing unit 30B provided to correspond to the monochrome sensor 310B are inputted in common.

The processing unit 30C performs signal processing of the data Da and the data Db time-divisionally, on the basis of the additional information indicated by the header Hd, and outputs the data Da and the data Db after signal processing to the processing unit 30D in the next stage.

The processing unit 30D performs processing of the data Da and the data Db time-divisionally, on the basis of the additional information indicated by the header Hd. The processing unit 30D outputs the data Da after signal processing to the SW processing unit 40A, and outputs the data Db after signal processing to the SW processing unit 40A.

Thus, even if the multiple external devices are a combination of the RGB sensor 310A and the monochrome sensor 310B, it is possible to share a portion where common signal processing is possible, out of the multiple stages of signal processing system hardware. In this case, in shared hardware, control by the CPU 2 is unnecessary when processing data time-divisionally, and the processing is not limited by performance of the CPU 2.

### Fourth Specific Example

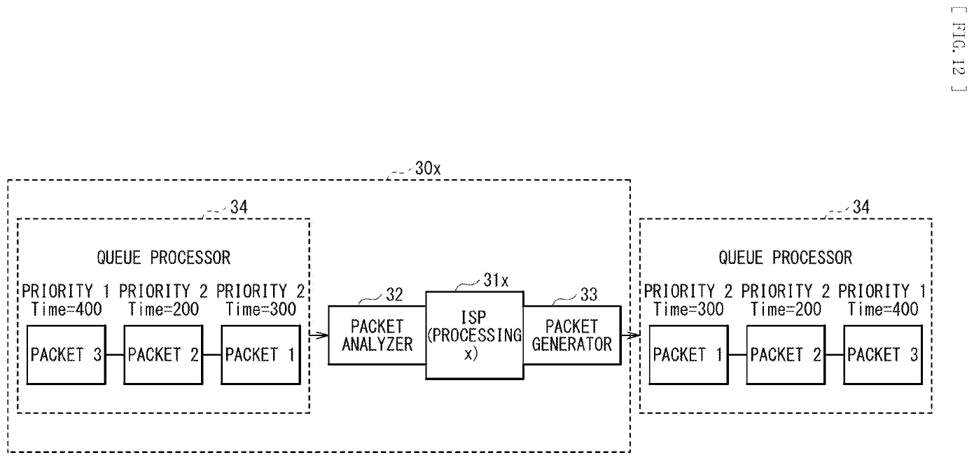

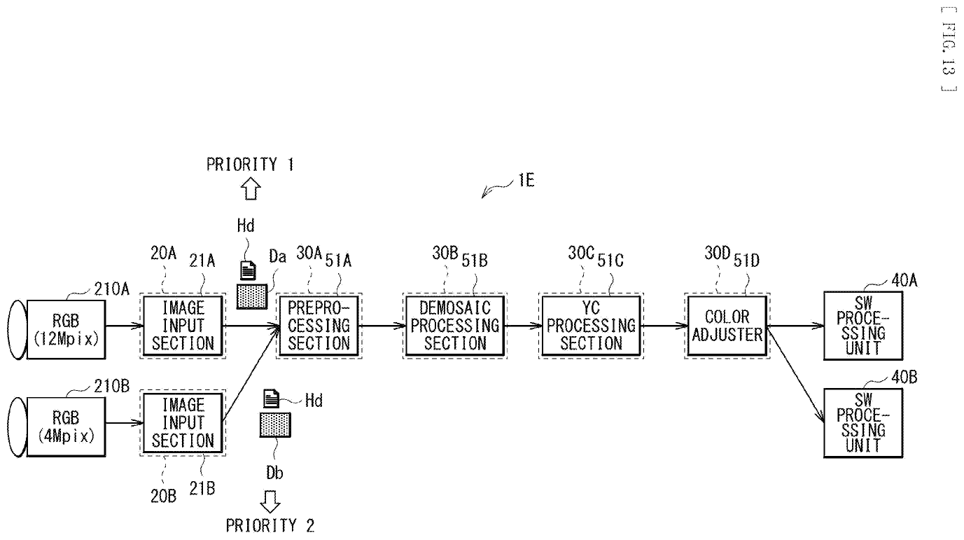

FIG. 11 illustrates a fourth specific example of the configuration of the signal processing device 1 according to the first embodiment.

A signal processing device 1D according to the fourth specific example illustrated in FIG. 11 represents a configuration example in a case of processing data outputted from a sensor 410A and a sensor 410B as the multiple external devices. The multiple external devices and the signal processing device 1D may configure an imaging apparatus as a whole. Note that illustration of the CPU 2 is omitted in FIG. 11.

The above specific examples represent examples in which a combination of an RGB sensor and an RGB sensor or a combination of an RGB sensor and a monochrome sensor is used as the multiple external devices. However, sensors to be used as the multiple external devices are not limited to these combinations. The sensor 410A and the sensor 410B may be, for example, a combination of any multiple sensors of the same kind or different kinds, out of an RGB sensor, a monochrome sensor, a polarization sensor, a multispectral sensor, a ToF (Time of Flight) sensor, a DVS (Dynamic Vision Sensor) sensor, and the like.

The signal processing device 1D includes the multiple input units 20A and provided to correspond to the sensor 410A and the sensor 410B. The data from the sensor 410A is inputted to the input unit 20A. The data from the sensor 410B is inputted to the input unit 20B.

The signal processing device 1D further includes the unillustrated CPU 2, multiple stages of signal processing system hardware, and the multiple SW processing units 40A and 40B.

FIG. 11 illustrates a configuration example in a case where the multiple stages of processing units 30A, 30B, 30C, and 30D provided to correspond to the sensor 410A are present, as the multiple stages of signal processing system hardware. In addition, FIG. 11 illustrates a configuration example in a case where the multiple stages of processing units 30A and 30B provided to correspond to the sensor 410B are present, as the signal processing system hardware.

The multiple stages of processing units 30A, 30B, 30C, and 30D include multiple stages of ISPs 31A, 31B, and 31C, and 31D respectively. The multiple stages of ISPs 31A, 31B, and 31C, and 31D perform processing A, processing B, processing C, and processing D respectively as signal processing.

On the basis of an instruction from the CPU 2, the input unit 20A generates a packet in which additional information including, for example, a routing instruction is added to the header Hd of the data Da from the sensor 410A, and outputs the packet to the processing unit 30A provided to correspond to the sensor 410A. The data Da from the processing unit 30A provided to correspond to the sensor 410A is inputted to the processing unit 30B provided to correspond to the sensor 410A.

On the basis of an instruction from the CPU 2, the input unit 20B generates a packet in which additional information including, for example, a routing instruction is added to the header Hd of the data Db from the sensor 410B, and outputs the packet to the processing unit 30A provided to correspond to the sensor 410B. The data Db from the processing unit 30A provided to correspond to the sensor 410B is inputted to the processing unit 30B provided to correspond to the sensor 410B.

To the processing unit 30C, the data Da from the processing unit 30B provided to correspond to the sensor 410A, and the data Db from the processing unit 30B provided to correspond to the sensor 410B are inputted in common. The processing unit performs signal processing of the data Da and the data Db time divisionally, on the basis of the additional information indicated by the header Hd, and outputs the data Da and the data Db after signal processing to the processing unit 30B in the next stage.

The processing unit 30D performs processing of the data Da and the data Db time-divisionally, on the basis of the additional information indicated by the header Hd. The processing unit 30D outputs the data Da after signal processing to the SW processing unit 40A, and outputs the data Db after signal processing to the SW processing unit 40A.

Thus, even if the multiple external devices are a combination of the sensor 410A and the sensor 410B, it is possible to share a portion where common signal processing is possible, out of the multiple stages of signal processing system hardware. In this case, in shared hardware, control by the CPU 2 is unnecessary when processing data time-divisionally, and the processing is not limited by performance of the CPU 2.

### Fifth Specific Example

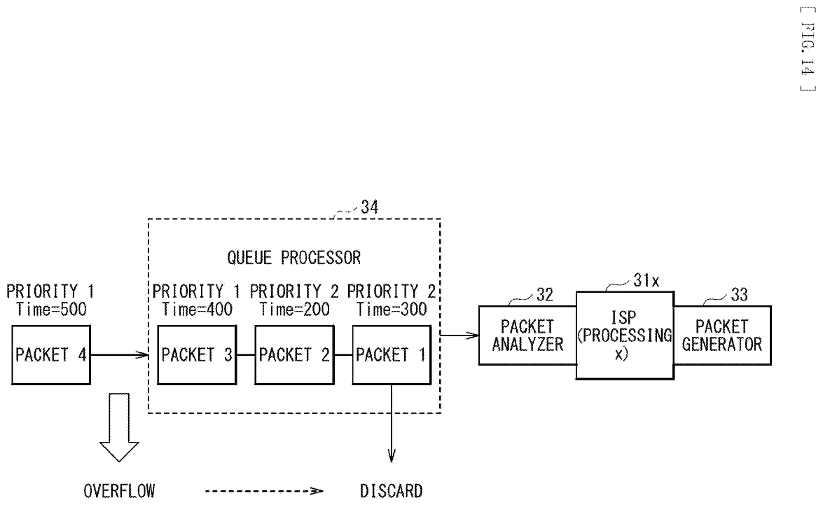

FIG. 12 illustrates a specific example of queue processing to be performed by the queue processor 34 in the signal processing device 1 according to the first embodiment.

Any processing unit 30x in the signal processing device 1 may include the queue processor 34 in the input stage of the packet analyzer 32. The queue processor 34 performs queue processing on each of multiple pieces of data, on the basis of information indicating a priority added to the header Hd of the packet.

The processing unit 30x performs signal processing in the order of the priority. In this case, as illustrated in FIG. 12, in a case where there are multiple packets with the same priority, the processing unit 30x performs signal processing in the order of, for example, a time stamp, and outputs the packets to the queue processor 34 in the next stage in the order in which signal processing is performed.

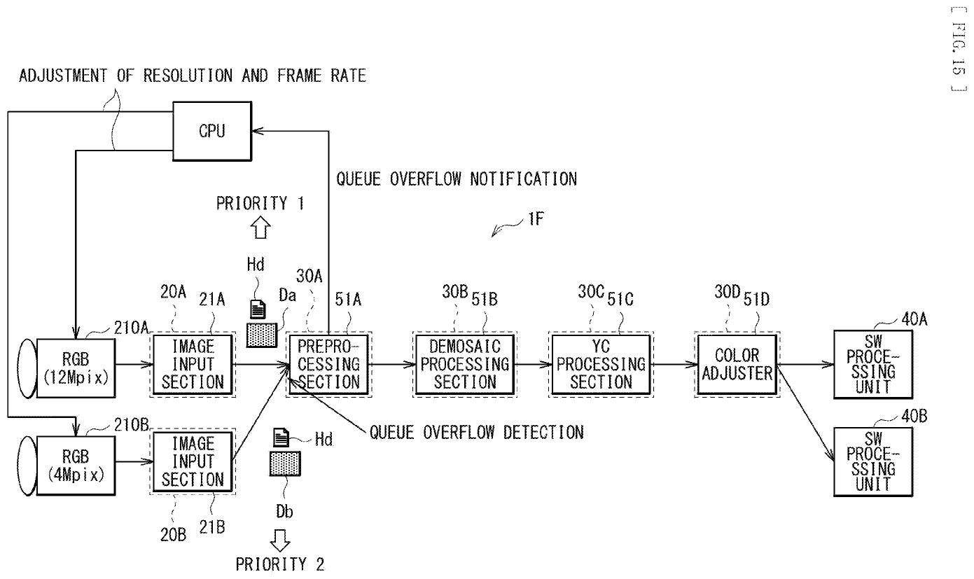

FIG. 13 illustrates a fifth specific example of the configuration of the signal processing device 1 according to the first embodiment.

A signal processing device 1E according to the fifth specific example may have a configuration substantially similar to that of the signal processing device 1B according to the second specific example illustrated in FIG. 7, except for a configuration related to the priority.

The signal processing device 1E represents a configuration example in a case of processing data outputted from the RGB sensor 210A and the RGB sensor 210B having different pixel sizes from each other, as the multiple external devices. The multiple external devices and the signal processing device 1E may configure an imaging apparatus as a whole. Note that illustration of the CPU 2 is omitted in FIG. 13.

The RGB sensor 210A is an image sensor having a higher resolution than the RGB sensor 210B. FIG. 13 illustrates an example in which the pixel size of the RGB sensor 210A is, for example, 12 Mpix, and the pixel size of the RGB sensor 210B is, for example, 4 Mpix.

On the basis of an instruction from the CPU 2, the input unit 20A generates a packet in which additional information including, for example, a routing instruction is added to the header Hd of the data Da from the RGB sensor 210A, and outputs the packet to the processing unit 30A. In addition, on the basis of an instruction from the CPU 2, the input unit 20A includes information indicating a priority as additional information in the header Hd of the data Da.

On the basis of an instruction from the CPU 2, the input unit 20B generates a packet in which additional information including, for example, a routing instruction is added to the header Hd of the data Db from the RGB sensor 210B, and outputs the packet to the processing unit 30A. In addition, on the basis of an instruction from the CPU 2, the input unit 20B includes information indicating a priority as additional information in the header Hd of the data Db.

The signal processing device 1E may, for example, set a higher priority for the data Da from the RGB sensor 210A which is an image sensor with a higher resolution, and set a lower priority for the data Db from the RGB sensor 210B which is an image sensor with a lower resolution, to preferentially process the data Da with a higher resolution.

### Sixth Specific Example

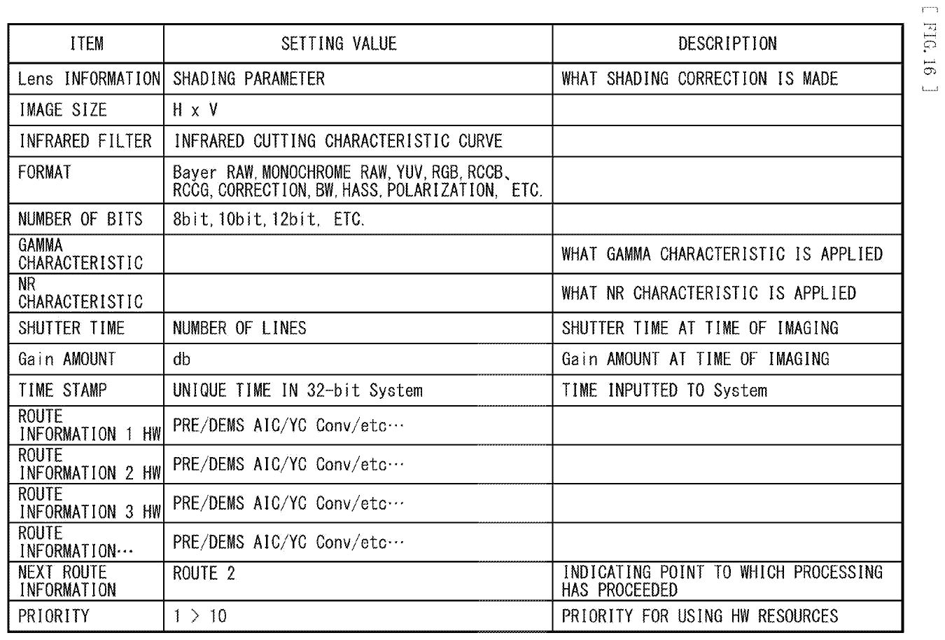

FIG. 14 illustrates a specific example of queue processing to be performed by the queue processor 34 in the signal processing device 1 according to the first embodiment.

In a case where a queue overflow occurs, the queue processor 34 may discard data of which the priority is relatively low, out of the multiple pieces of data.

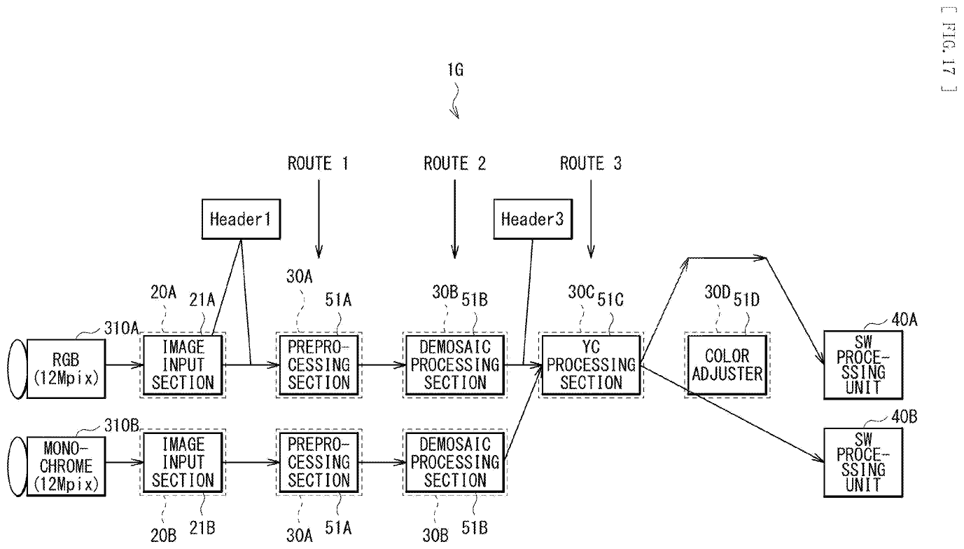

FIG. 15 illustrates a sixth specific example of the configuration of the signal processing device 1 according to the first embodiment.

A signal processing device 1F according to the sixth specific example may have a configuration substantially similar to that of the signal processing device 1E according to the fifth specific example illustrated in FIG. 13, except for a configuration related to processing in a case where a queue overflow occurs.

In a case where a queue overflow occurs, the queue processor 34 may provide the CPU 2 with a notification that the queue overflow has occurred. On the basis of the notification from the queue processor 34, the CPU 2 may adjust the setting value of each of the RGB sensor 210A and the RGB sensor 210B serving as the multiple external devices. The CPU 2 may adjust, for example, setting values of a resolution and a frame rate, for the RGB sensor 210A and the RGB sensor 210B.

### Seventh Specific Example

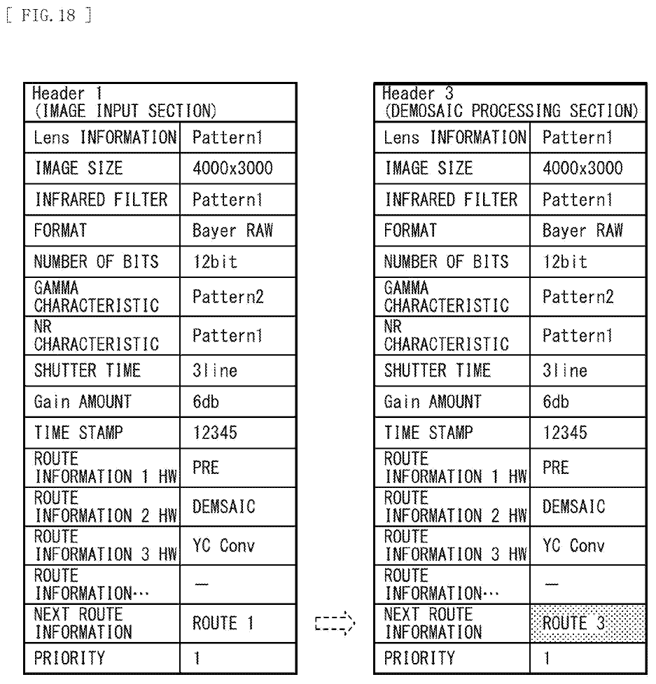

FIG. 16 is an explanatory diagram illustrating an example of the additional information (header information) to be added to the packet by the signal processing device 1 according to the first embodiment.

As illustrated in FIG. 16, items of the header information to be added by the signal processing device 1 may include, for example, Lens information, an image size, an infrared filter, a format, the number of bits, a gamma characteristic, an NR characteristic, a shutter time, a Gain amount, a time stamp, route information, and information on a priority. The route information may include “next route information” indicating information on the processing unit in the next stage.

FIG. 17 illustrates a seventh specific example of the configuration of the signal processing device 1 according to the first embodiment.

A signal processing device 1G according to the seventh specific example may have a configuration substantially similar to that of the signal processing device 1C according to the third specific example illustrated in FIG. 10, except for a route of signal processing.

In the signal processing device 1G, the multiple stages of processing units 30B, 30C, and 30D are present as the multiple stages of signal processing system hardware.

The processing unit 30A includes the preprocessing section 51A. The processing unit 30B includes the demosaic processing section 51B. The processing unit includes the Y (luminance) C (chroma) processing section. The processing unit includes the color adjuster 51D.

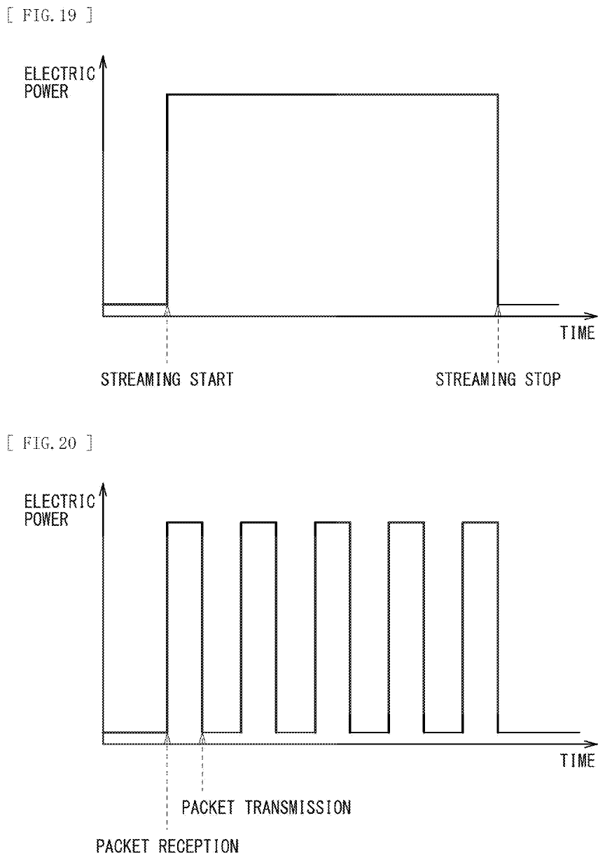

FIG. 18 illustrates an example of the additional information (header information) to be added by the signal processing device 1G according to the seventh specific example. FIG. 18 illustrates an example of the header information (Header 1) added to the packet outputted from the input unit 20A and the header information (Header 3) added to the packet outputted from the processing unit 30B.

For example, the “next route information” indicating information on the processing unit in the next stage is updated, by going through each processing unit.

Note that it is desirable that the header information do not contain the actual value of a large-size parameter such as a filter parameter. In addition, as the header information, the value of each parameter may be separately held in a memory, instead of containing the value itself of each parameter. In that case, the header information may contain information indicating where the value of the parameter is in the memory.

### Concerning Amount of Consumed Power

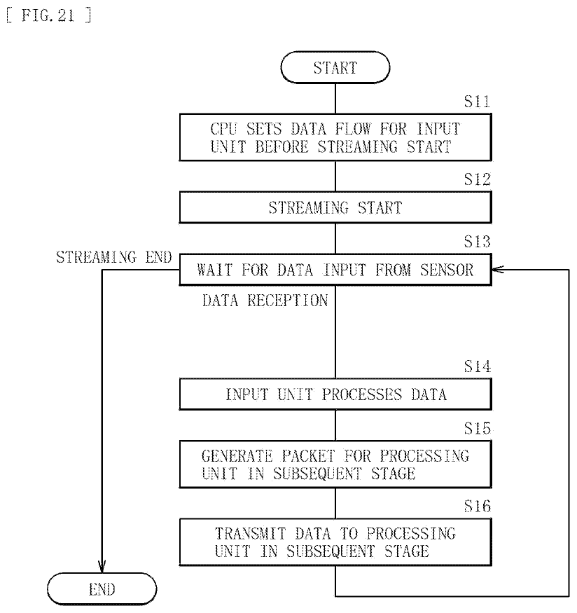

FIG. 19 illustrates an example of an amount of electric power consumed by the processing unit in the signal processing device 100 according to the comparative example. FIG. 20 illustrates an example of an amount of electric power consumed by the processing unit in the signal processing device 1 according to the first embodiment.

In the signal processing device 100 according to the comparative example (FIG. 1), as illustrated in FIG. 19, each processing unit that performs signal processing has to operate at all times in a period from start to stop of data input (streaming) from the external device, and consumes a large amount of electric power.

In contrast, in the signal processing device 1 according to the first embodiment, as illustrated in FIG. 20, each processing unit that performs signal processing has to operate only in at least a period from reception of a packet on which signal processing is to be performed to transmission of a packet to the processing unit in the next stage, and consumes a small amount of electric power.

### 1.3 Operation

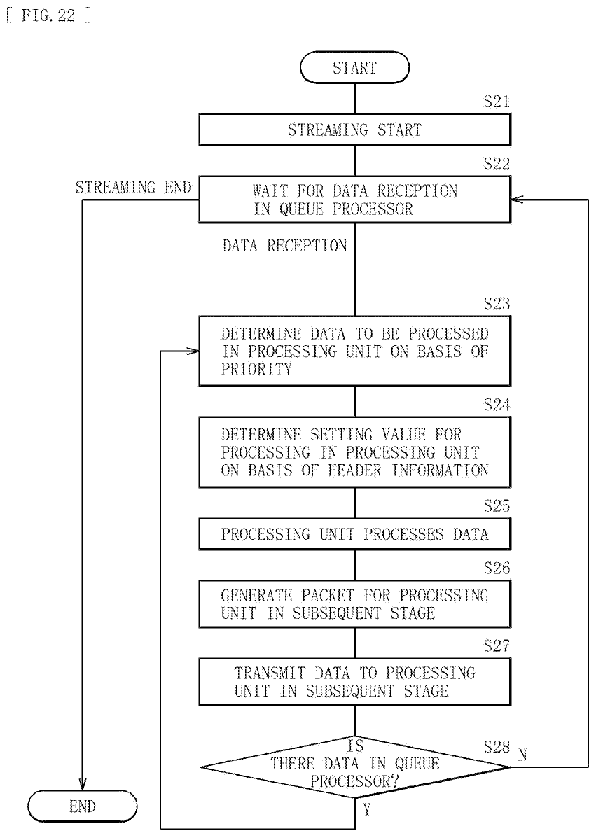

Referring to FIGS. 21 and 22, operation of the signal processing device 1 illustrated in FIG. 2 is described below.

FIG. 21 is a flowchart illustrating an example of operation related to each of the multiple input units 20A, 20B, and 20C in the signal processing device 1.

First, before data input (streaming) from each of the multiple sensors 10A, 10B, and 10C is started, the CPU 2 sets, for each of the multiple input units 20A, 20B, and 20C, data flow to be a basis for additional information necessary for signal processing (step S11). Next, streaming from each of the multiple sensors 10A, 10B, and 10C is started (step S12).

The multiple input units 20A, 20B, and 20C wait for input from the multiple sensors 10A, 10B, and 10C respectively (step S13). The multiple input units 20A, 20B, and 20C each end processing in a case where streaming of each of the multiple sensors 10A, 10B, and 10C ends.

In a case where pieces of data from the multiple sensors 10A, 10B, and 10C are received respectively, the multiple input units 20A, 20B, and 20C start processing of the pieces of data (step S14). The multiple input units 20A, 20B, and 20C each perform a packet generation process for the processing unit in the subsequent stage (step S15). Next, the multiple input units 20A, 20B, and 20C each transmit data packetized and including the additional information added as the header information, to the processing unit in the subsequent stage (step S16).

FIG. 22 is a flowchart illustrating an example of operation related to each of the multiple stages of processing units 30A, 30B, and 30C in the signal processing device.

First, streaming from each of the multiple sensors 10A, 10B, and 10C is started (step S21). The multiple stages of processing units 30A, 30B, and 30C each wait for data reception in the queue processor 34 (step S22). The multiple stages of processing units 30A, 30B, and 30C each end processing in a case where streaming of each of the multiple sensors 10A, 10B, and 10C ends.

In a case where data is received in the queue processor 34, the multiple stages of processing units 30A, 30B, and 30C each determine the data to be processed on the basis of the information indicating the priority indicated by the header information (step S23). Next, the multiple stages of processing units 30A, 30B, and 30C each determine the setting value for processing, on the basis of the header information (step S24). Next, the multiple stages of processing units 30A, 30B, and 30C each start processing of the data (step S25).

The multiple stages of processing units 30A, 30B, and 30C each perform a packet generation process for the processing unit in the subsequent stage (step S26). Next, the multiple stages of processing units 30A, 30B, and 30C each transmit packetized data to the processing unit in the subsequent stage (step S27). Next, the multiple stages of processing units 30A, 30B, and 30C each determine whether or not there is data in the queue processor 34 (step S28). In a case where determination is made that there is no data in the queue processor 34 (step S28; N), the process returns to step S22. In a case where determination is made that there is data in the queue processor 34 (step S28; Y), the process returns to step S23.

### 1.4 Effects

As described above, in the signal processing device 1 according to the first embodiment, in each of the multiple stages of signal processing system hardware, common signal processing is performed on each of the multiple pieces of data, on the basis of the additional information added to each of the multiple pieces of data. This makes it possible to perform signal processing on the multiple pieces of data, while suppressing a circuit scale and electric power consumption.

In the signal processing device 1 according to the first embodiment, the multiple stages of signal processing system hardware are shared by the multiple external devices, which makes it possible to reduce a hardware scale. In the signal processing device 1 according to the first embodiment, data flow of the signal processing system hardware proceeds without intervention of the CPU 2 or the DSP 3, which allows the CPU 2 to concentrate on processing other than signal processing. In the signal processing device 1 according to the first embodiment, routing for the multiple stages of signal processing system hardware is performed in units of packets, which makes it possible to suppress electric power consumption during standby for signal processing.

It is to be noted that the effects described in the present specification are merely examples and not limitative, and other effects may be achieved. The same applies to effects of the following other embodiments.

### 2. Other Embodiments

The technology according to the present disclosure is not limited to the description of the embodiment described above, and various modifications may be made.

For example, the present technology may have the following configurations.

According to the present technology having the following configurations, in each of the multiple stages of processing units, common signal processing is performed on each of the multiple pieces of data, on the basis of the additional information added to each of the multiple pieces of data. This makes it possible to perform signal processing on the multiple pieces of data, while suppressing a circuit scale and electric power consumption.

(1)

A signal processing device including:

multiple input units that add additional information necessary for signal processing to each of multiple pieces of data inputted from respective multiple external devices, and output the multiple pieces of data; and multiple stages of processing units each configured to perform common signal

processing on each of the multiple pieces of data, on the basis of the additional information.

(2)

The signal processing device according to (1), in which the additional information includes

instruction information indicating an instruction as to signal processing using which processing unit, out of the multiple stages of processing units, is to be performed on each of the multiple pieces of data, and

setting information indicating a setting value to be used for signal processing in each of the multiple stages of processing units.

(3)

The signal processing device according to (1) or (2), in which the additional information includes information indicating a priority for signal processing of each of the multiple pieces of data in each of the multiple stages of processing units.

(4)

The signal processing device according to any one of (1) to (3), further including a controller that instructs each of the multiple input units as to signal processing using which processing unit, out of the multiple stages of processing units, is to be performed.

(5)

The signal processing device according to any one of (1) to (4), in which the multiple input units each include a first packet generator that generates a packet of each of the multiple pieces of data, adds the additional information as a header to the packet, and outputs the packet.

(6)

The signal processing device according to (5), in which the multiple stages of processing units each include

a packet analyzer that analyzes the header added to the packet, and determines a setting value to be used for signal processing, and

a second packet generator that generates a packet in which information to be used for signal processing of the processing unit in the next stage is added as the additional information to a header.

(7)

The signal processing device according to (3), in which the multiple stages of processing units each further include a queue processor that performs queue processing on each of the multiple pieces of data, on the basis of the information indicating the priority.

(8)

The signal processing device according to (7), in which, in a case where a queue overflow occurs, the queue processor discards data of which the priority is relatively low, out of the multiple pieces of data.

(9)

The signal processing device according to (8), further including a controller that is able to adjust setting values of the multiple external devices, in which,

in a case where a queue overflow occurs, the queue processor provides the controller with a notification that the queue overflow has occurred, and

the controller adjusts the setting values of the multiple external devices, on the basis of the notification from the queue processor.

(10)

A signal processing method including:

adding additional information necessary for signal processing to each of multiple pieces of data inputted from respective multiple external devices, and outputting the multiple pieces of data; and

performing, in each of multiple stages of processing units, common signal processing on each of the multiple pieces of data, on the basis of the additional information.

(11)

An imaging apparatus including:

multiple sensors;

multiple input units that add additional information necessary for signal processing to each of multiple pieces of data inputted from the respective multiple sensors, and output the multiple pieces of data; and

multiple stages of processing units each configured to perform common signal processing on each of the multiple pieces of data, on the basis of the additional information.

This application claims the benefit of Japanese Priority Patent Application JP2020-186819 filed with the Japan Patent Office on Nov. 9, 2020, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A signal processing device comprising:
multiple input units that add additional information necessary for signal processing to each of multiple pieces of data inputted from respective multiple external devices, and output the multiple pieces of data; and
multiple stages of processing units each configured to perform common signal processing on each of the multiple pieces of data, on a basis of the additional information.

2. The signal processing device according to claim 1, wherein the additional information includes
instruction information indicating an instruction as to signal processing using which processing unit, out of the multiple stages of processing units, is to be performed on each of the multiple pieces of data, and
setting information indicating a setting value to be used for signal processing in each of the multiple stages of processing units.

3. The signal processing device according to claim 1, wherein the additional information includes information indicating a priority for signal processing of each of the multiple pieces of data in each of the multiple stages of processing units.

4. The signal processing device according to claim 1, further comprising a controller that instructs each of the multiple input units as to signal processing using which processing unit, out of the multiple stages of processing units, is to be performed.

5. The signal processing device according to claim 1, wherein the multiple input units each include a first packet generator that generates a packet of each of the multiple pieces of data, adds the additional information as a header to the packet, and outputs the packet.

6. The signal processing device according to claim 5, wherein the multiple stages of processing units each include
a packet analyzer that analyzes the header added to the packet, and determines a setting value to be used for signal processing, and
a second packet generator that generates a packet in which information to be used for signal processing of the processing unit in the next stage is added as the additional information to a header.

7. The signal processing device according to claim 3, wherein the multiple stages of processing units each further include a queue processor that performs queue processing on each of the multiple pieces of data, on a basis of the information indicating the priority.

8. The signal processing device according to claim 7, wherein, in a case where a queue overflow occurs, the queue processor discards data of which the priority is relatively low, out of the multiple pieces of data.

9. The signal processing device according to claim 8, further comprising a controller that is able to adjust setting values of the multiple external devices, wherein,
in a case where a queue overflow occurs, the queue processor provides the controller with a notification that the queue overflow has occurred, and
the controller adjusts the setting values of the multiple external devices, on a basis of the notification from the queue processor.

10. A signal processing method comprising:
adding additional information necessary for signal processing to each of multiple pieces of data inputted from respective multiple external devices, and outputting the multiple pieces of data; and
performing, in each of multiple stages of processing units, common signal processing on each of the multiple pieces of data, on a basis of the additional information.

11. An imaging apparatus comprising:
multiple sensors;
multiple input units that add additional information necessary for signal processing to each of multiple pieces of data inputted from the respective multiple sensors, and output the multiple pieces of data; and
multiple stages of processing units each configured to perform common signal processing on each of the multiple pieces of data, on a basis of the additional information.
